(19) United States
(12) Patent Application Publication
(10) Pub. No.: US 2010/0086146 A1
(43) Pub. Date: Apr. 8, 2010

(54) SILICON-BASED MICROPHONE PACKAGE

(75) Inventors: Shih-Chin GONG, Taipei (TW); Wei-Chan HSU, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/244,187

(22) Filed: Oct. 2, 2008

(51) Int. Cl. H04R 1/02

(52) U.S. Cl. 381/91

(57) ABSTRACT

A microphone package includes a carrier, a cap, a first silicon-based microphone, and a first integrated circuit chip. The carrier has a first storage space. The cap has a planar part contacting the carrier and a plurality of flanges extending from the planar part and surrounding the carrier. The first silicon-based microphone is disposed in the first storage space and covered by the cap. The first integrated circuit chip is disposed in the first storage space, electrically connected to the first silicon-based microphone, and covered by the cap.

### BACKGROUND OF THE INVENTION

1. Field of the Invention

The invention relates to a microphone package, and more particularly to a silicon-based microphone package.

2. Description of the Related Art

Electronic devices are becoming increasingly compact and lightweight. Many electronic devices have microphones inside. Therefore, providing a small-sized microphone is required.

Silicon-based microphones are popular due to their small sizes. U.S. Pat. No. 6,781,231 discloses a silicon-based microphone package. As shown in FIG. 1, a cover 20 is disposed on a substrate 23. The cover 20 serving as an environmental and electromagnetic interference shield includes an outer cup 25a and an inner cup 25b. A plurality of electronic elements 12 is disposed in a chamber 36 formed by the cover 20 and the substrate 23. The cover 20 has a plurality of acoustic ports 44 and 48 allowing the electronic elements 12 to receive external sound.

U.S. Patent Application Publication No. 2007/0278601 discloses another silicon-based microphone package. As shown in FIG. 2, a MEMS die 110 is mounted on a chip carrier 120 and encapsulated by an enclosure 130. The chip carrier 120 has an acoustic hole 125 covered by the MEMS die 110. The enclosure 130 is used for preventing transmission of any electromagnetic radiation from the MEMS die 110, and any electromagnetic radiation from interfering with the MEMS die 110. The enclosure 130 may be molded using a thermoplastic or thermosetting polymer material, such as an epoxy molding compound, liquid crystal polymer, or polyetheretherketone (PEEK), and an electrically conductive material, such as metal particles or carbon fibers or fillers.

U.S. Pat. No. 6,522,762 discloses another silicon-based microphone package. As shown in FIG. 3, a transducer 1 and an integrated circuit chip 3 are flip-chip mounted on a silicon carrier substrate 2. The transducer 1 and the integrated circuit chip 3 are electrically connected. The second surface of the silicon carrier substrate 2 is supplied with a plurality of solder bumps 22 for surface mounting onto a printed circuit board (not shown). A lid 5 provides EMI (electromagnetic interference) shielding. An EMI shield 16 is a conductive polymer layer such as a silver epoxy, or a metal layer such as electroplated or evaporated Cu or Au.

U.S. Pat. No. 7,202,552 discloses another silicon-based microphone package. As shown in FIG. 4, the package 70 has a MEMS device 40 attached to the flexible substrate 10. A metal cap 54 encapsulates the MEMS device 40 on the flexible substrate 10. The flexible substrate 10 is folded over the metal cap 54 and glued to the top of the metal cap 54. The metal cap 54 and the metal layer of the flexible substrate 10 are electrically connected to form a Faraday cage for EMI/RF shielding.

### BRIEF SUMMARY OF THE INVENTION

The invention provides a silicon-based microphone package differing from conventional silicon-based microphone packages. The microphone package in accordance with an exemplary embodiment of the invention includes a carrier, a cap, a first silicon-based microphone, and a first integrated circuit chip. The carrier has a first storage space. The cap has a planar part contacting the carrier and a plurality of flanges extending from the planar part and surrounding the carrier. The first silicon-based microphone is disposed in the first storage space and covered by the cap. The first integrated circuit chip is disposed in the first storage space, electrically connected to the first silicon-based microphone, and covered by the cap.

In another exemplary embodiment of the invention, the cap further has an acoustic hole connecting the first storage space to the exterior of the microphone package and allowing the first silicon-based microphone in the first storage space to receive external sound.

In yet another exemplary embodiment of the invention, the carrier further has an acoustic hole connecting the first storage space to an exterior of the microphone package and allowing the first silicon-based microphone in the first storage space to receive external sound.

In another exemplary embodiment of the invention, the microphone package further includes a second silicon-based microphone. The carrier further has a second storage space. The second silicon-based microphone is disposed in the second storage space and covered by the cap.

In yet another exemplary embodiment of the invention, the microphone package further includes a second integrated circuit chip disposed in the second storage space, electrically connected to the second silicon-based microphone, and covered by the cap.

In another exemplary embodiment of the invention, the cap further has an acoustic hole connecting the second storage space to the exterior of the microphone package and allowing the second silicon-based microphone in the second storage space to receive external sound.

In yet another exemplary embodiment of the invention, the carrier further has an acoustic hole connecting the second storage space to the exterior of the microphone package and allowing the second silicon-based microphone in the second storage space to receive external sound.

In another exemplary embodiment of the invention, the first silicon-based microphone has a bottom cavity. The carrier further has a channel connecting the bottom cavity to the exterior of the microphone package and allowing the first silicon-based microphone to receive external sound.

In yet another exemplary embodiment of the invention, the first silicon-based microphone has a bottom cavity. The cap further has an acoustic hole. The carrier further has a channel connecting the bottom cavity to the acoustic hole and allowing the first silicon-based microphone to receive external sound.

In another exemplary embodiment of the invention, the cap is made of a thermoplastic polymer material.

In yet another exemplary embodiment of the invention, the cap is made of a thermosetting polymer material.

In another exemplary embodiment of the invention, the cap is made of an electrically conductive material.

In yet another exemplary embodiment of the invention, the carrier is a printed circuit board.

In another exemplary embodiment of the invention, the carrier is made of ceramic.

In yet another exemplary embodiment of the invention, the microphone package includes a carrier, a cap, and a first microphone die. The carrier has a first storage space. The cap has a planar part contacting the carrier and a plurality of flanges extending from the planar part and surrounding the carrier. The first microphone die, including a first silicon-based microphone and a first integrated circuit, is disposed in the first storage space and covered by the cap.

In another exemplary embodiment of the invention, the cap further has an acoustic hole connecting the first storage space to the exterior of the microphone package and allowing the first silicon-based microphone of the first microphone die in the first storage space to receive external sound.

In yet another exemplary embodiment of the invention, the carrier further has an acoustic hole connecting the first storage space to the exterior of the microphone package and allowing the first silicon-based microphone of the first microphone die in the first storage space to receive external sound.

In another exemplary embodiment of the invention, the microphone package further includes a second microphone die. The second microphone die includes a second silicon-based microphone and a second integrated circuit. The carrier further has a second storage space. The second microphone die is disposed in the second storage space and covered by the cap.

In yet another exemplary embodiment of the invention, the cap further has an acoustic hole connecting the second storage space to the exterior of the microphone package and allowing the second silicon-based microphone of the second microphone die in the second storage space to receive external sound.

In another exemplary embodiment of the invention, the carrier further has an acoustic hole connecting the second storage space to the exterior of the microphone package and allowing the second silicon-based microphone of the second microphone die in the second storage space to receive external sound.

In yet another exemplary embodiment of the invention, the cap is made of a thermoplastic polymer material.

In another exemplary embodiment of the invention, the cap is made of a thermosetting polymer material.

In yet another exemplary embodiment of the invention, the cap is made of an electrically conductive material.

In another exemplary embodiment of the invention, the carrier is a printed circuit board.

In yet another exemplary embodiment of the invention, the carrier is made of ceramic.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a silicon-based microphone package disclosed in U.S. Pat. No. 6,781,231;

FIG. 2 is a schematic diagram of a silicon-based microphone package disclosed in U.S. Patent Application Publication No. 2007/0278601;

FIG. 3 is a schematic diagram of a silicon-based microphone package disclosed in U.S. Pat. No. 6,522,762;

FIG. 4 is a schematic diagram of a silicon-based microphone package disclosed in U.S. Pat. No. 7,202,552;

FIG. 5 is a schematic diagram of a microphone package in accordance with a first embodiment of the invention;

FIG. 6 is a schematic diagram of a microphone package in accordance with a second embodiment of the invention;

FIG. 7 is a schematic diagram of a microphone package in accordance with a third embodiment of the invention;

FIG. 8 is a schematic diagram of a microphone package in accordance with a fourth embodiment of the invention;

FIG. 9 is a schematic diagram of a microphone package in accordance with a fifth embodiment of the invention;

FIG. 10 is a schematic diagram of a microphone package in accordance with a sixth embodiment of the invention;

FIG. 11 is a schematic diagram of a microphone package in accordance with a seventh embodiment of the invention; and

FIG. 12 is a schematic diagram of a microphone package in accordance with an eighth embodiment of the invention.

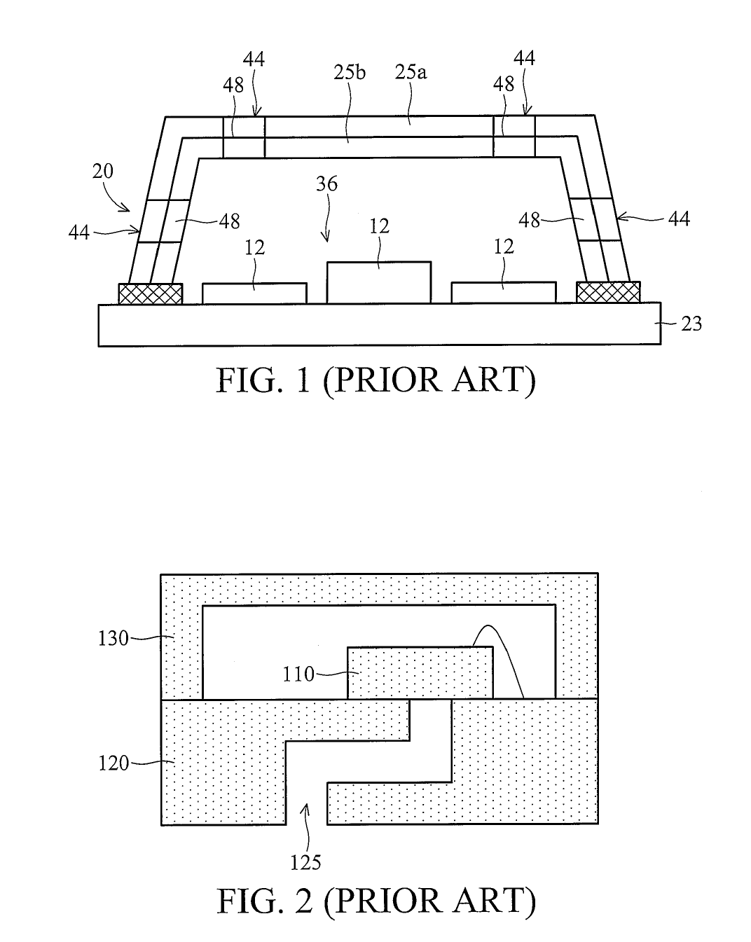

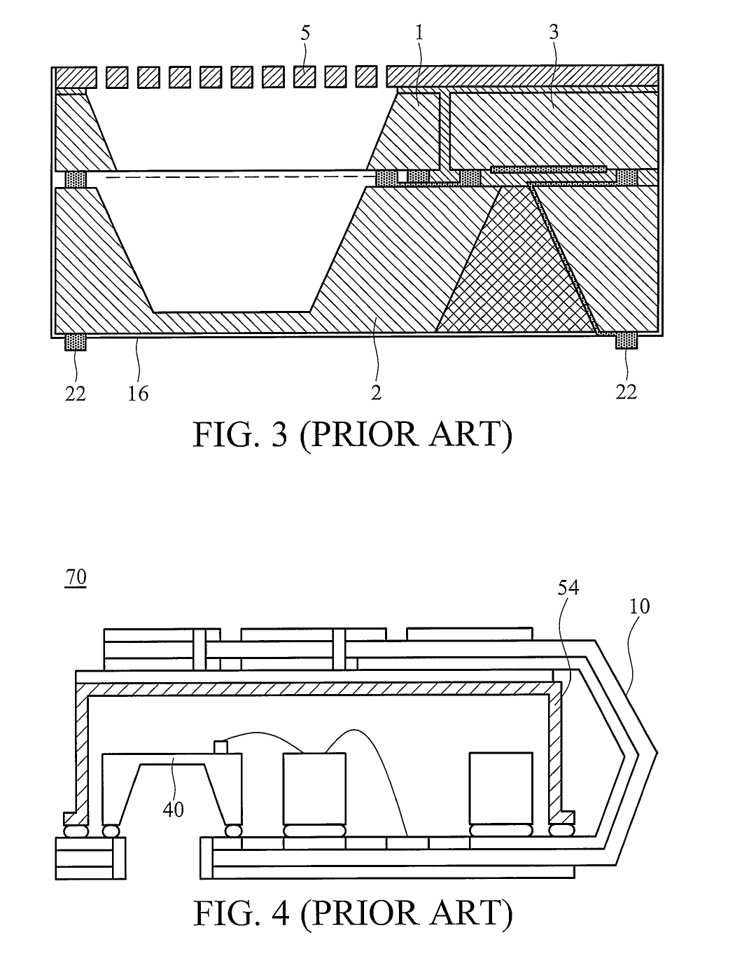

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

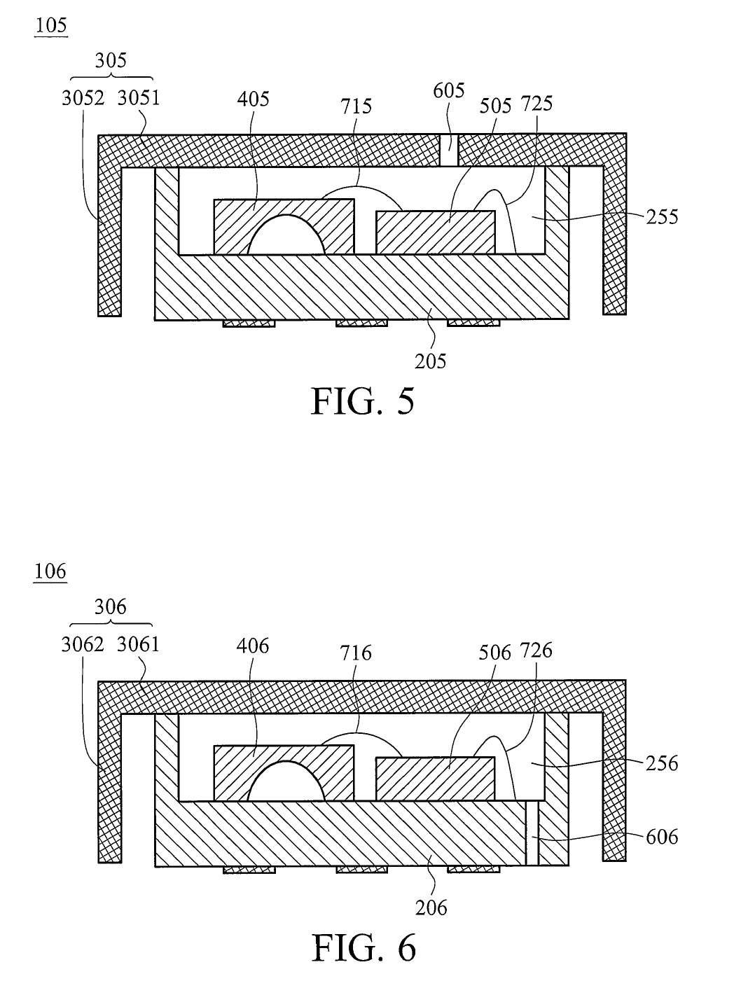

Referring to FIG. 5, a microphone package 105 of a first embodiment of the invention includes a carrier 205, a cap 305, an integrated circuit (IC) chip 505, and a silicon-based microphone 405.

The carrier 205 is a multi-layered printed circuit board (PCB) or a ceramic board, or is pre-molded to form a storage space 255. The silicon-based microphone 405 and the IC chip 505 are disposed in the storage space 255 and covered by the cap 305.

The cap 305 has a planar part 3051 contacting the carrier 205 and a plurality of flanges 3052 extending from the planar part 3051 and surrounding the carrier 205. An acoustic hole 605, provided in the cap 305, connects the storage space 255 to the exterior of the microphone package 105 and allows the silicon-based microphone 405 in the storage space 255 to receive external sound. The cap 305 may be made of a thermoplastic or thermosetting polymer material such as an epoxy molding compound, liquid crystal polymer, or polyetheretherketone (PEEK), or an electrically conductive material such as metal or an alloy.

The silicon-based microphone 405 is mounted on the carrier 205 and electrically connected to the IC chip 505 through a bonding wire 715. In operation, the silicon-based microphone 405 receives external sound through the acoustic hole 605 of the cap 305.

The IC chip 505, mounted on the carrier 205, is used for providing impedance matching and amplifying the sound signal from the silicon-based microphone 405. A charge pump, an analog-to-digital (A/D) converter, and a digital signal processor (DSP) may be included in the IC chip 505. Furthermore, the IC chip 505 is electrically connected to the carrier 205 through a bonding wire 725.

Referring to FIG. 6, a microphone package 106 of a second embodiment of the invention includes a carrier 206, a cap 306, an IC chip 506, and a silicon-based microphone 406.

The carrier 206 is a multi-layered printed circuit board or a ceramic board, or is pre-molded to form a storage space 256. The silicon-based microphone 406 and the IC chip 506 are disposed in the storage space 256 and covered by the cap 306.

The cap 306 has a planar part 3061 contacting the carrier 206 and a plurality of flanges 3062 extending from the planar part 3061 and surrounding the carrier 206. An acoustic hole 606, provided in the carrier 206, connects the storage space 256 to the exterior of the microphone package 106 and allows the silicon-based microphone 406 in the storage space 256 to receive external sound. The cap 306 may be made of a thermoplastic or thermosetting polymer material such as epoxy molding compound, liquid crystal polymer, or polyetheretherketone (PEEK), or an electrically conductive material such as metal or an alloy.

The silicon-based microphone 406 is mounted on the carrier 206 and electrically connected to the IC chip 506 through a bonding wire 716. In operation, the silicon-based microphone 406 receives external sound through the acoustic hole 606 of the carrier 206.

The IC chip 506 is mounted on the carrier 206, for providing impedance matching and amplifying the sound signal from the silicon-based microphone 406. A charge pump, an analog-to-digital (A/D) converter, and a digital signal processor (DSP) may be included in the IC chip 506. Furthermore, the IC chip 506 is electrically connected to the carrier 206 through a bonding wire 726.

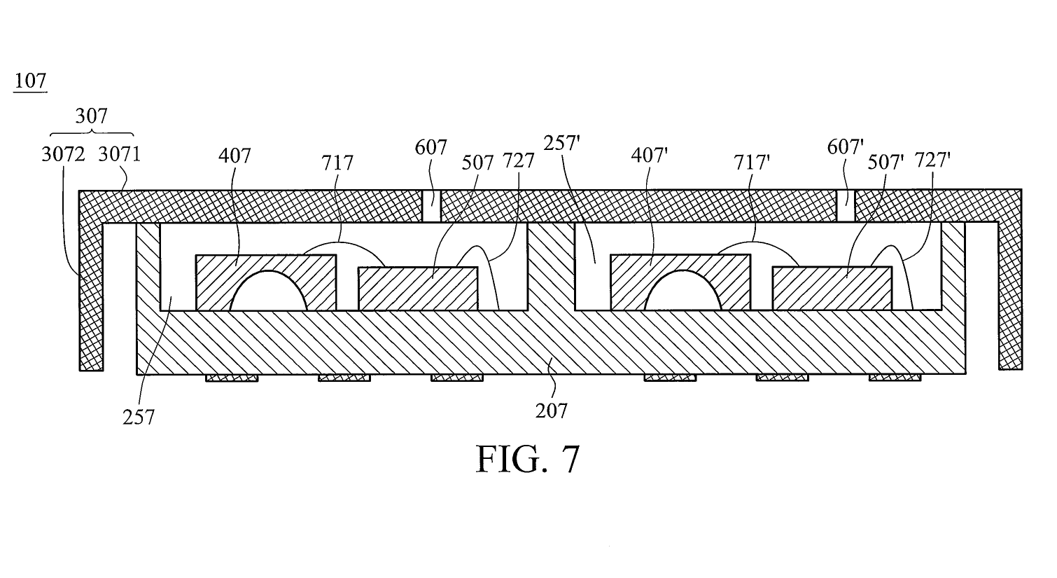

Referring to FIG. 7, a microphone package 107 of a third embodiment of the invention includes a carrier 207, a cap 307, a first IC chip 507, a second IC chip 507′, a first silicon-based microphone 407, and a second silicon-based microphone 407′.

The carrier 207 is a multi-layered printed circuit board (PCB) or a ceramic board, or is pre-molded to form a first storage space 257 and a second storage space 257′. The first silicon-based microphone 407 and the first IC chip 507 are disposed in the first storage space 257 and covered by the cap 307. Similarly, the second silicon-based microphone 407′ and the second IC chip 507′ are disposed in the second storage space 257′ and covered by the cap 307.

The cap 307 has a planar part 3071 contacting the carrier 207 and a plurality of flanges 3072 extending from the planar part 3071 and surrounding the carrier 207. A first acoustic hole 607 and a second acoustic hole 607′ are provided in the cap 307. The first acoustic hole 607 connects the first storage space 257 to the exterior of the microphone package 107 and allows the first silicon-based microphone 407 in the first storage space 257 to receive external sound. The second acoustic hole 607′ connects the second storage space 257′ to the exterior of the microphone package 107 and allows the second silicon-based microphone 407′ in the second storage space 257′ to receive external sound. The cap 307 may be made of a thermoplastic or thermosetting polymer material such as epoxy molding compound, liquid crystal polymer, or polyetheretherketone (PEEK), or an electrically conductive material such as metal or an alloy.

The first silicon-based microphone 407 is mounted on the carrier 207 and electrically connected to the first IC chip 507 through a bonding wire 717. In operation, the first silicon-based microphone 407 receives external sound through the first acoustic hole 607 of the cap 307.

Similarly, the second silicon-based microphone 407′ is mounted on the carrier 207 and electrically connected to the second IC chip 507′ through a bonding wire 717′. In operation, the second silicon-based microphone 407′ receives external sound through the second acoustic hole 607′ of the cap 307.

The first IC chip 507 is mounted on the carrier 207, for providing impedance matching and amplifying the sound signal from the first silicon-based microphone 407. A charge pump, an analog-to-digital (A/D) converter, and a digital signal processor (DSP) may be included in the first IC chip 507. Furthermore, the first IC chip 507 is electrically connected to the carrier 205 through a bonding wire 727.

Similarly, the second IC chip 507′ is mounted on the carrier 207, for providing impedance matching and amplifying the sound signal from the second silicon-based microphone 407′. A charge pump, an analog-to-digital (A/D) converter, and a digital signal processor (DSP) may be included in the second IC chip 507′. Furthermore, the second IC chip 507′ is electrically connected to the carrier 207 through a bonding wire 727′.

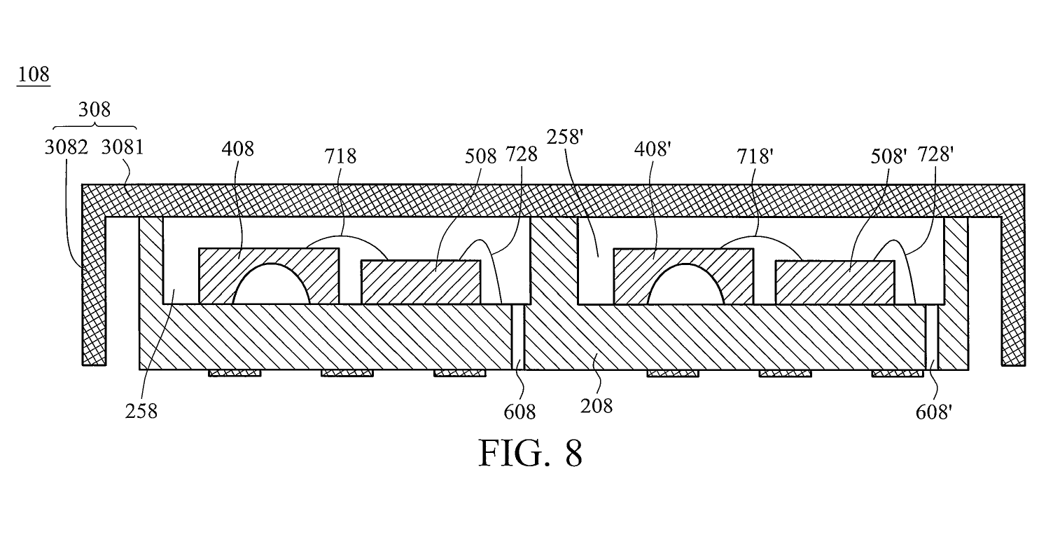

Referring to FIG. 8, a microphone package 108 of a fourth embodiment of the invention includes a carrier 208, a cap 308, a first IC chip 508, a second IC chip 508′, a first silicon-based microphone 408, and a second silicon-based microphone 408′.

The carrier 208 is a multi-layered printed circuit board (PCB) or a ceramic board, or is pre-molded to form a first storage space 258 and a second storage space 258′. The first silicon-based microphone 408 and the first IC chip 508 are disposed in the first storage space 258 and covered by the cap 308. Similarly, the second silicon-based microphone 408′ and the second IC chip 508′ are disposed in the second storage space 258′ and covered by the cap 308.

The cap 308 has a planar part 3081 contacting the carrier 208 and a plurality of flanges 3082 extending from the planar part 3081 and surrounding the carrier 208. A first acoustic hole 608 and a second acoustic hole 608′ are provided in the carrier 208. The first acoustic hole 608 connects the first storage space 258 to the exterior of the microphone package 108 and allows the first silicon-based microphone 408 in the first storage space 258 to receive external sound. The second acoustic hole 608′ connects the second storage space 258′ to the exterior of the microphone package 108 and allows the second silicon-based microphone 408′ in the second storage space 258′ to receive external sound. The cap 308 may be made of a thermoplastic or thermosetting polymer material such as epoxy molding compound, liquid crystal polymer, or polyetheretherketone (PEEK), or an electrically conductive material such as metal or an alloy.

The first silicon-based microphone 408 is mounted on the carrier 208 and electrically connected to the first IC chip 508 through a bonding wire 718. In operation, the first silicon-based microphone 408 receives external sound through the first acoustic hole 608 of the carrier 208.

Similarly, the second silicon-based microphone 408′ is mounted on the carrier 208 and electrically connected to the second IC chip 508′ through a bonding wire 718′. In operation, the second silicon-based microphone 408′ receives external sound through the second acoustic hole 608′ of the carrier 208.

The first IC chip 508 is mounted on the carrier 208, for providing impedance matching and amplifying the sound signal from the first silicon-based microphone 408. A charge pump, an analog-to-digital (A/D) converter, and a digital signal processor (DSP) may be included in the first IC chip 508. Furthermore, the first IC chip 508 is electrically connected to the carrier 208 through a bonding wire 728.

Similarly, the second IC chip 508′ is mounted on the carrier 208, for providing impedance matching and amplifying the sound signal from the second silicon-based microphone 408′. A charge pump, an analog-to-digital (A/D) converter, and a digital signal processor (DSP) may be included in the second IC chip 508′. Furthermore, the second IC chip 508′ is electrically connected to the carrier 208 through a bonding wire 728′.

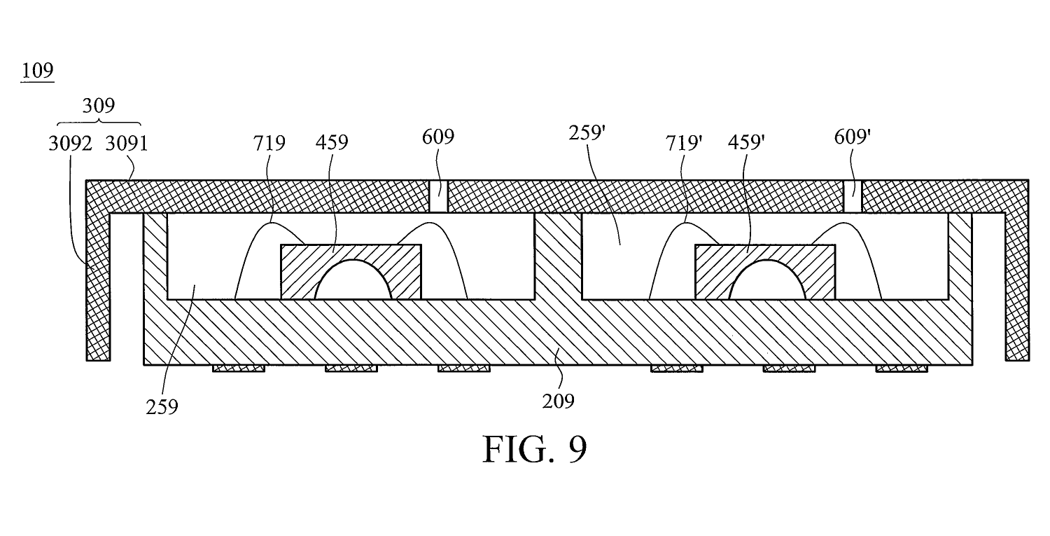

Referring to FIG. 9, a microphone package 109 of a fifth embodiment of the invention includes a carrier 209, a cap 309, a first microphone die 459, and a second microphone die 459′.

The carrier 209 is a multi-layered printed circuit board (PCB) or a ceramic board, or is pre-molded to form a first storage space 259 and a second storage space 259′. The first microphone die 459 is disposed in the first storage space 259 and covered by the cap 309. Similarly, the second microphone die 459′ is disposed in the second storage space 259′ and covered by the cap 309.

The cap 309 has a planar part 3091 contacting the carrier 209 and a plurality of flanges 3092 extending from the planar part 3091 and surrounding the carrier 209. A first acoustic hole 609 and a second acoustic hole 609′ are provided in the cap 309. The first acoustic hole 609 connects the first storage space 259 to the exterior of the microphone package 107 and allows the first microphone die 459 in the first storage space 259 to receive external sound. The second acoustic hole 609′ connects the second storage space 259′ to the exterior of the microphone package 109 and allows the second microphone die 459′ in the second storage space 259′ to receive external sound. The cap 309 may be made of a thermoplastic or thermosetting polymer material such as epoxy molding compound, liquid crystal polymer, or polyetheretherketone (PEEK), or an electrically conductive material such as metal or an alloy.

The first microphone die 459 includes a first silicon-based microphone and a first integrated circuit. The first silicon-based microphone is capable of receiving external sound through the first acoustic hole 609 of the cap 309. The first integrated circuit is used for providing impedance matching and amplifying the sound signal from the first silicon-based microphone. Furthermore, a charge pump, an analog-to-digital (A/D) converter, and a digital signal processor (DSP) may be included in the first microphone die 459.

Similarly, the second microphone die 459′ includes a second silicon-based microphone and a second integrated circuit. The second silicon-based microphone is capable of receiving external sound through the second acoustic hole 609′ of the cap 309. The second integrated circuit is used for providing impedance matching and amplifying the sound signal from the second silicon-based microphone. Furthermore, a charge pump, an analog-to-digital (A/D) converter, and a digital signal processor (DSP) may be included in the second microphone die 459′.

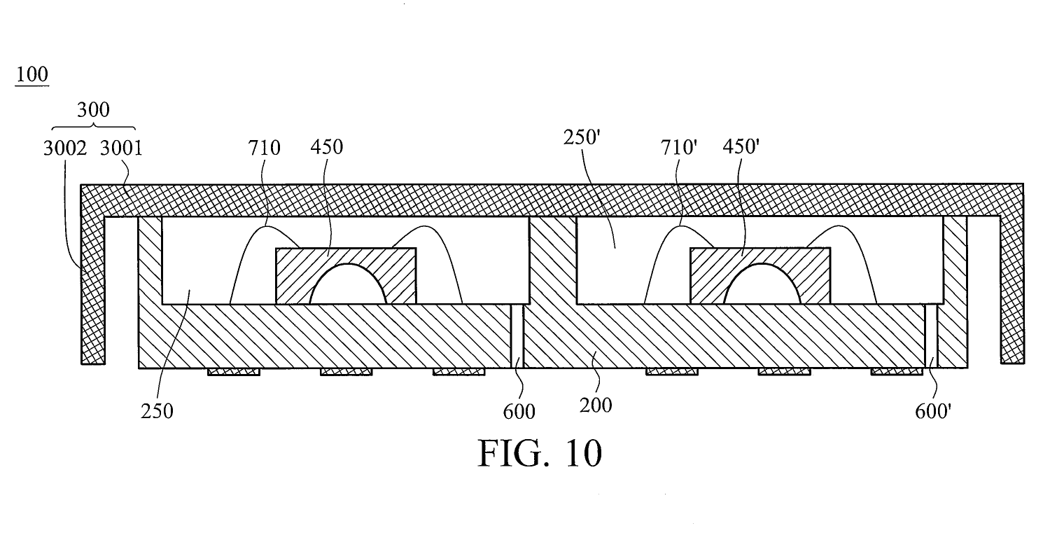

Referring to FIG. 10, a microphone package 100 of a sixth embodiment of the invention includes a carrier 200, a cap 300, a first microphone die 450, and a second microphone die 450′.

The carrier 200 is a multi-layered printed circuit board (PCB) or a ceramic board, or is pre-molded to form a first storage space 250 and a second storage space 250′. The first microphone die 450 is disposed in the first storage space 250 and covered by the cap 300. Similarly, the second microphone die 450′ is disposed in the second storage space 250′ and covered by the cap 300.

The cap 300 has a planar part 3001 contacting the carrier 200 and a plurality of flanges 3002 extending from the planar part 3001 and surrounding the carrier 200. A first acoustic hole 600 and a second acoustic hole 600′ are provided in the carrier 200. The first acoustic hole 600 connects the first storage space 250 to the exterior of the microphone package 100 and allows the first microphone die 450 in the first storage space 250 to receive external sound. The second acoustic hole 609′ connects the second storage space 250′ to the exterior of the microphone package 100 and allows the second microphone die 450′ in the second storage space 250′ to receive external sound. The cap 300 may be made of a thermoplastic or thermosetting polymer material such as epoxy molding compound, liquid crystal polymer, or polyetheretherketone (PEEK), or an electrically conductive material such as metal or an alloy.

The first microphone die 450 includes a first silicon-based microphone and a first integrated circuit. The first silicon-based microphone is capable of receiving external sound through the first acoustic hole 600 of the carrier 200. The first integrated circuit is used for providing impedance matching and amplifying the sound signal from the first silicon-based microphone. Furthermore, a charge pump, an analog-to-digital (A/D) converter, and a digital signal processor (DSP) may be included in the first microphone die 450.

Similarly, the second microphone die 450′ includes a second silicon-based microphone and a second integrated circuit. The second silicon-based microphone is capable of receiving external sound through the second acoustic hole 600′ of the carrier 200. The second integrated circuit is used for providing impedance matching and amplifying the sound signal from the second silicon-based microphone. Furthermore, a charge pump, an analog-to-digital (A/D) converter, and a digital signal processor (DSP) may be included in the second microphone die 450′.

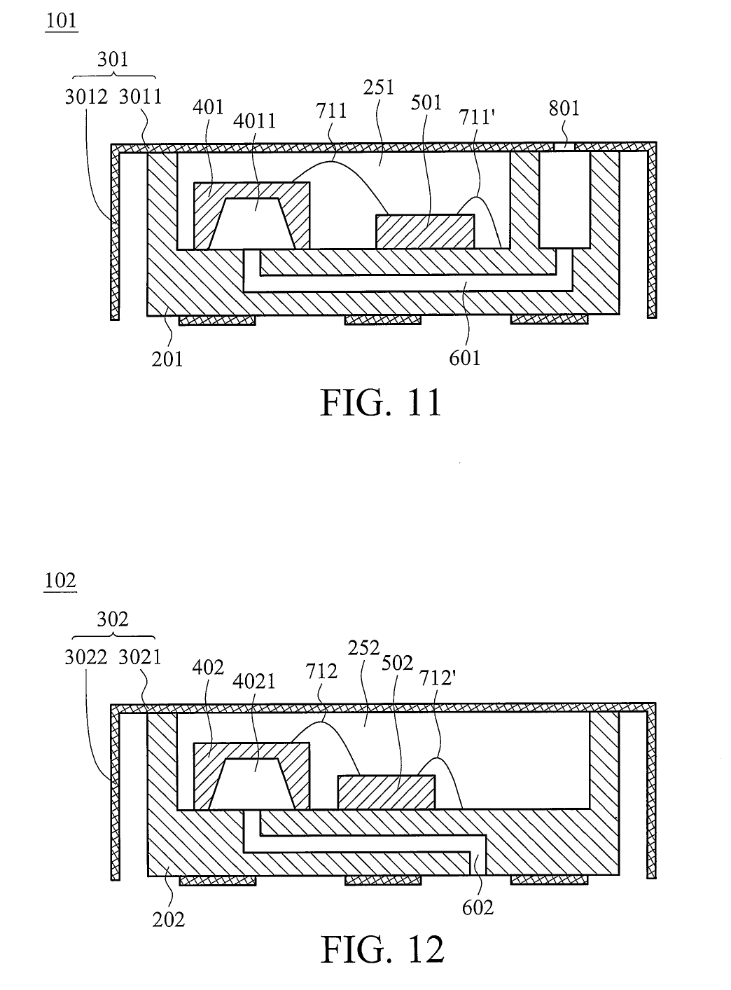

Referring to FIG. 11, a microphone package 101 of a seventh embodiment of the invention includes a carrier 201, a cap 301, an integrated circuit (IC) chip 501, and a silicon-based microphone 401.

The carrier 201 is a multi-layered printed circuit board (PCB) or a ceramic board, or is pre-molded to form a storage space 251. The silicon-based microphone 401 and the IC chip 501 are disposed in the storage space 251 and covered by the cap 301. Furthermore, the carrier 201 has a channel 601 extending from the silicon-based microphone 401 to the cap 301.

The cap 301 has a planar part 3011 contacting the carrier 201 and a plurality of flanges 3012 extending from the planar part 3011 and surrounding the carrier 201. An acoustic hole 801 is provided in the cap 301 and connected to the channel 601 of the carrier 201, allowing the silicon-based microphone 401 in the storage space 251 to receive external sound. The cap 301 may be made of a thermoplastic or thermosetting polymer material such as epoxy molding compound, liquid crystal polymer, or polyetheretherketone (PEEK), or an electrically conductive material such as metal or an alloy.

The silicon-based microphone 401 is mounted on the carrier 201 and electrically connected to the IC chip 501 through a bonding wire 711. The silicon-based microphone 401 has a bottom cavity 4011 which is connected to the exterior of the microphone package 101 through the channel 601 and the acoustic hole 801, for receiving external sound.

The IC chip 501 is mounted on the carrier 201, for providing impedance matching and amplifying the sound signal from the silicon-based microphone 401. A charge pump, an analog-to-digital (A/D) converter, and a digital signal processor (DSP) may be included in the IC chip 501. Furthermore, the IC chip 501 is electrically connected to the carrier 201 through a bonding wire 711′.

Referring to FIG. 12, a microphone package 102 of an eighth embodiment of the invention includes a carrier 202, a cap 302, an integrated circuit (IC) chip 502, and a silicon-based microphone 402.

The carrier 202 is a multi-layered printed circuit board (PCB) or a ceramic board, or is pre-molded to form a storage space 252. The silicon-based microphone 402 and the IC chip 502 are disposed in the storage space 252 and covered by the cap 302. Furthermore, the carrier 202 has a channel 602 extending to the silicon-based microphone 402, allowing the silicon-based microphone 402 in the storage space 252 to receive external sound.

The cap 302 has a planar part 3021 contacting the carrier 202 and a plurality of flanges 3022 extending from the planar part 3021 and surrounding the carrier 202. The cap 302 may be made of a thermoplastic or thermosetting polymer material such as epoxy molding compound, liquid crystal polymer, or polyetheretherketone (PEEK), or an electrically conductive material such as metal or an alloy.

The silicon-based microphone 402 is mounted on the carrier 202 and electrically connected to the IC chip 502 through a bonding wire 712. The silicon-based microphone 402 has a bottom cavity 4021 which is connected to the exterior of the microphone package 102 through the channel 602 of the carrier 202, for receiving external sound.

The IC chip 502 is mounted on the carrier 202, for providing impedance matching and amplifying the sound signal from the silicon-based microphone 402. A charge pump, an analog-to-digital (A/D) converter, and a digital signal processor (DSP) may be included in the IC chip 502. Furthermore, the IC chip 502 is electrically connected to the carrier 202 through a bonding wire 712′.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone package, comprising:
a carrier having a first storage space;
a cap having a planar part contacting the carrier and a plurality of flanges extending from the planar part and surrounding the carrier;
a first silicon-based microphone disposed in the first storage space and covered by the cap; and
a first integrated circuit chip disposed in the first storage space, electrically connected to the first silicon-based microphone, and covered by the cap.

2. The microphone package as claimed in claim 1, wherein the cap further has an acoustic hole connecting the first storage space to an exterior of the microphone package and allowing the first silicon-based microphone in the first storage space to receive external sound.

3. The microphone package as claimed in claim 1, wherein the carrier further has an acoustic hole connecting the first storage space to an exterior of the microphone package and allowing the first silicon-based microphone in the first storage space to receive external sound.

4. The microphone package as claimed in claim 1, further comprising a second silicon-based microphone, wherein the carrier further has a second storage space, and the second silicon-based microphone is disposed in the second storage space and covered by the cap.

5. The microphone package as claimed in claim 4, further comprising a second integrated circuit chip disposed in the second storage space, electrically connected to the second silicon-based microphone, and covered by the cap.

6. The microphone package as claimed in claim 4, wherein the cap further has an acoustic hole connecting the second storage space to an exterior of the microphone package and allowing the second silicon-based microphone in the second storage space to receive external sound.

7. The microphone package as claimed in claim 4, wherein the carrier further has an acoustic hole connecting the second storage space to an exterior of the microphone package and allowing the second silicon-based microphone in the second storage space to receive external sound.

8. The microphone package as claimed in claim 1, wherein the first silicon-based microphone has a bottom cavity, and the carrier further has a channel connecting the bottom cavity to an exterior of the microphone package and allowing the first silicon-based microphone to receive external sound.

9. The microphone package as claimed in claim 1, wherein the first silicon-based microphone has a bottom cavity, the cap further has an acoustic hole, and the carrier further has a channel connecting the bottom cavity to the acoustic hole and allowing the first silicon-based microphone to receive external sound.

10. The microphone package as claimed in claim 1, wherein the cap is made of a thermoplastic polymer material, a thermosetting polymer material, or an electrically conductive material.

11. The microphone package as claimed in claim 1, wherein the carrier is a printed circuit board.

12. The microphone package as claimed in claim 1, wherein the carrier is made of ceramic.

13. A microphone package, comprising:
a carrier having a first storage space;
a cap having a planar part contacting the carrier and a plurality of flanges extending from the planar part and surrounding the carrier; and
a first microphone die, including a first silicon-based microphone and a first integrated circuit, disposed in the first storage space and covered by the cap.

14. The microphone package as claimed in claim 13, wherein the cap further has an acoustic hole connecting the first storage space to an exterior of the microphone package and allowing the first silicon-based microphone of the first microphone die in the first storage space to receive external sound.

15. The microphone package as claimed in claim 13, wherein the carrier further has an acoustic hole connecting the first storage space to an exterior of the microphone package and allowing the first silicon-based microphone of the first microphone die in the first storage space to receive external sound.

16. The microphone package as claimed in claim 13, further comprising a second microphone die, wherein the second microphone die includes a second silicon-based microphone and a second integrated circuit, the carrier further has a second storage space, and the second microphone die is disposed in the second storage space and covered by the cap.

17. The microphone package as claimed in claim 16, wherein the cap further has an acoustic hole connecting the second storage space to an exterior of the microphone package and allowing the second silicon-based microphone of the second microphone die in the second storage space to receive external sound.

18. The microphone package as claimed in claim 16, wherein the carrier further has an acoustic hole connecting the second storage space to an exterior of the microphone package and allowing the second silicon-based microphone of the second microphone die in the second storage space to receive external sound.

19. The microphone package as claimed in claim 13, wherein the cap is made of a thermoplastic polymer material, a thermosetting polymer material, or an electrically conductive material.

20. The microphone package as claimed in claim 13, wherein the carrier is a printed circuit board.

21. The microphone package as claimed in claim 13, wherein the carrier is made of ceramic.
